(19) United States
(12) Patent Application Publication
(10) Pub. No.: US 2004/0100757 A1
(43) Pub. Date: May 27, 2004

(54) Medium-voltage switchgear assembly having low-voltage panels and medium-voltage panels

(75) Inventors: Uwe Hegmann, Osterholz-Scharmbeck (DE); Norbert Herbst, Bremen (DE); Bernd Kallbach, Oststeinbek (DE); Juergen Vollmerding, Hambergen (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AG

(21) Appl. No.: 10/631,728

(22) Filed: Aug. 1, 2003

Related U.S. Application Data
(63) Continuation of application No. PCT/DE02/00293, filed on Jan. 28, 2002.

(30) Foreign Application Priority Data
Feb. 1, 2001 (DE) 101 04 890.4

(51) Int. Cl. H02B 5/00

(52) U.S. Cl. 361/605

(57) ABSTRACT

A medium high voltage switchboard plant for ships, trains, train power supply systems, and the like, that has a plurality of switch cabinets. The individual switch cabinets have low voltage fields with automatic electrical control devices and medium high voltage fields with power switches.

This is a Continuation of International Application PCT/DE02/00293, with an international filing date of Jan. 28, 2002, which was published under PCT Article 21(2) in German, and the disclosure of which is incorporated into this application by reference.

### FIELD OF AND BACKGROUND OF THE INVENTION

The invention relates to a medium-voltage switchgear assembly for vessels, railroads, rail power supplies, etc. which is formed from individual switchgear cabinets. Medium-voltage switchgear assemblies for vessels, railroads, rail power supplies, etc. are subject to particular quality requirements, which can be found, for example, in the classification organization regulations. Related assemblies are known from and described in, e.g., European Patent Application EP 0 903 825 A2, German Patent Publication DE 43 12 924 A1, and the article “Gas-Insulated Switchboards rated up to 52 kV — Safe, Reliable and Maintenance-Free” by Dr. H. Fink et al. in ABB Review, No. 10 (1994) at pp. 25-31. Each of these three documents is incorporated into the present application by reference.

### OBJECTS OF THE INVENTION

An object of the invention is to specify a medium-voltage switchgear assembly which is safe, whose cost is low, which can be operated easily and which occupies only a small amount of space. A further object is to provide these and other advantages within the scope of the regulations as defined, e.g., by the classification organizations.

### SUMMARY OF THE INVENTION

These and other objects are achieved, according to one formulation, in that the individual switchgear cabinets have low-voltage panels with open-loop and closed-loop control devices and medium-voltage panels with circuit breakers. Further solution features are set forth in dependent claims and in the following description and the accompanying drawings, which disclose further inventive features in a form evident to those skilled in the art.

### BRIEF DESCRIPTION OF THE DRAWINGS

FIGS. 1-11 show, in a sequentially numbered form, views of a switchgear assembly and of individual panels, in the form of perspective views and sectional illustrations.

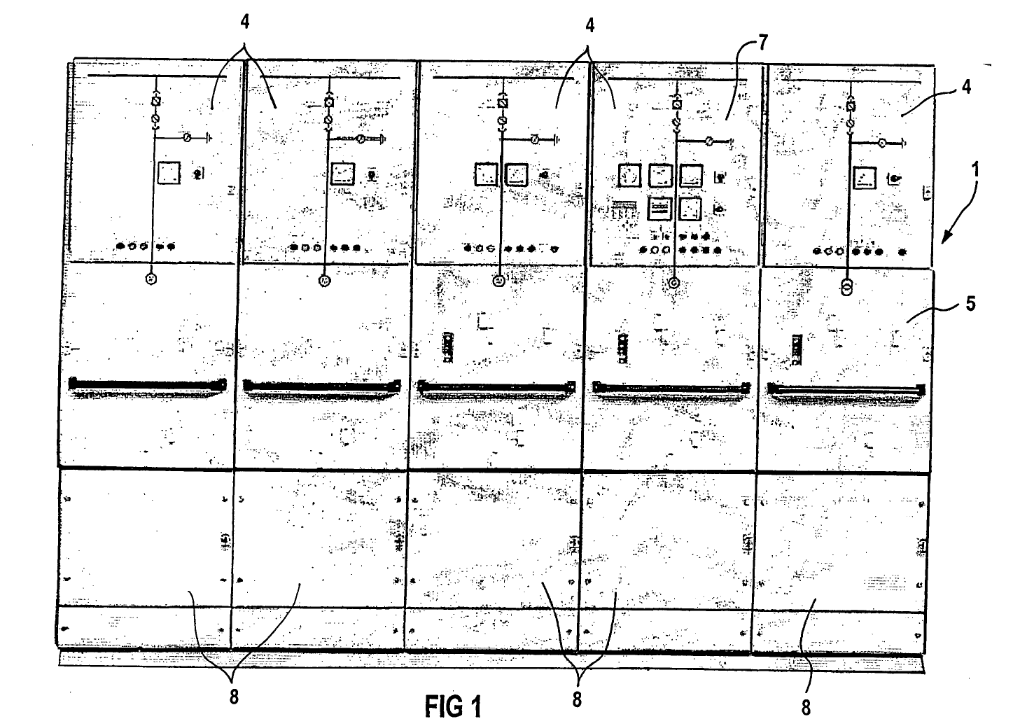

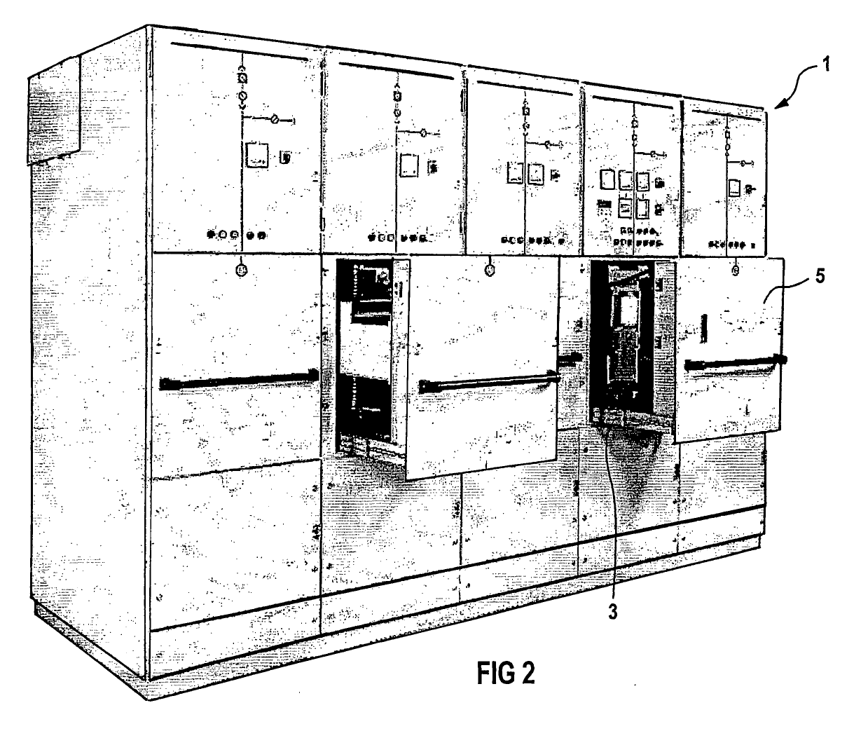

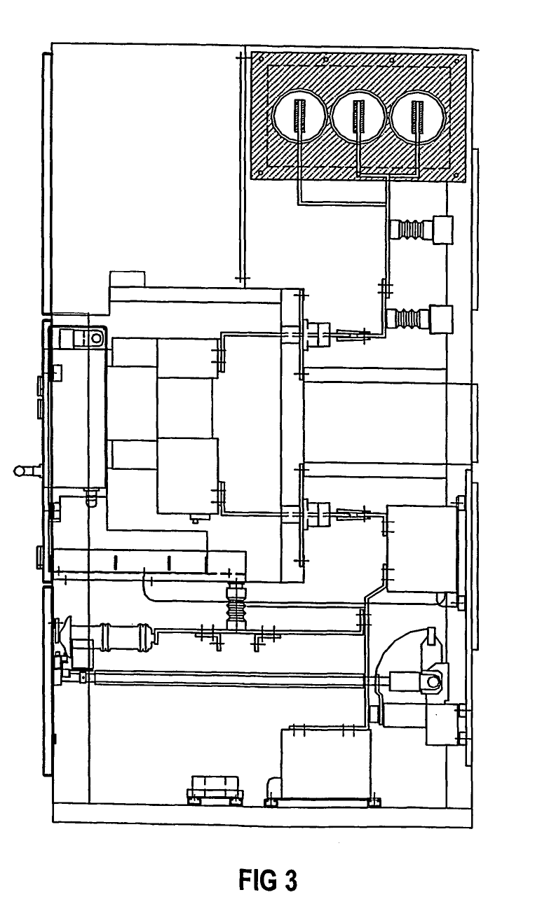

### DETAILED DESCRIPTION OF THE PREFERRED EMBODIMENTS

The medium-voltage switchgear assembly 1 provides a distribution system for medium-voltage networks, in particular in vessels. The assembly 1 is composed essentially of generator and load panels.

Regulations

The design and the electrical components that are fitted comply with applicable regulations. The vacuum interrupter 3AH and vacuum contactor 3TL which are used in this assembly 1 are licensed by the classification organizations Bureau Veritas, Germanischer Lloyd, Lloyds Register of Shipping and the Register of the Soviet Union.

Mechanical Design and Construction

The switchgear assembly 1 is composed of freestanding panels, some of which make use of a framework structure (welded 2.5 mm steel plate). In order to restrict the effects of a fault arc, the invention provides for partition of individual areas with pressure-relief flaps.

The switchgear assembly 1 is suitable for wall mounting, so long as an installation and blow-out area 500 mm is maintained behind the panels. All the pressure relief flaps are arranged to the rear, in order to protect the operating personnel.

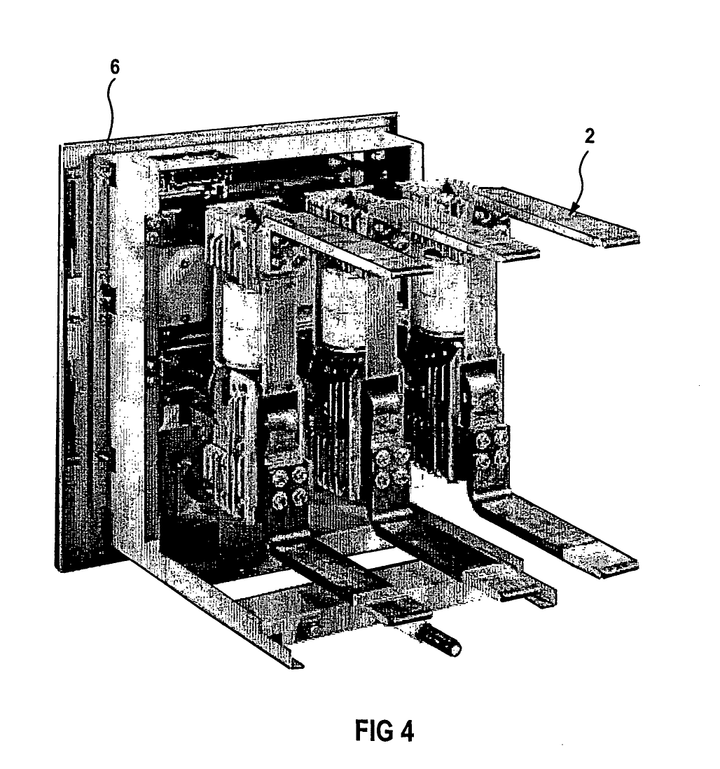

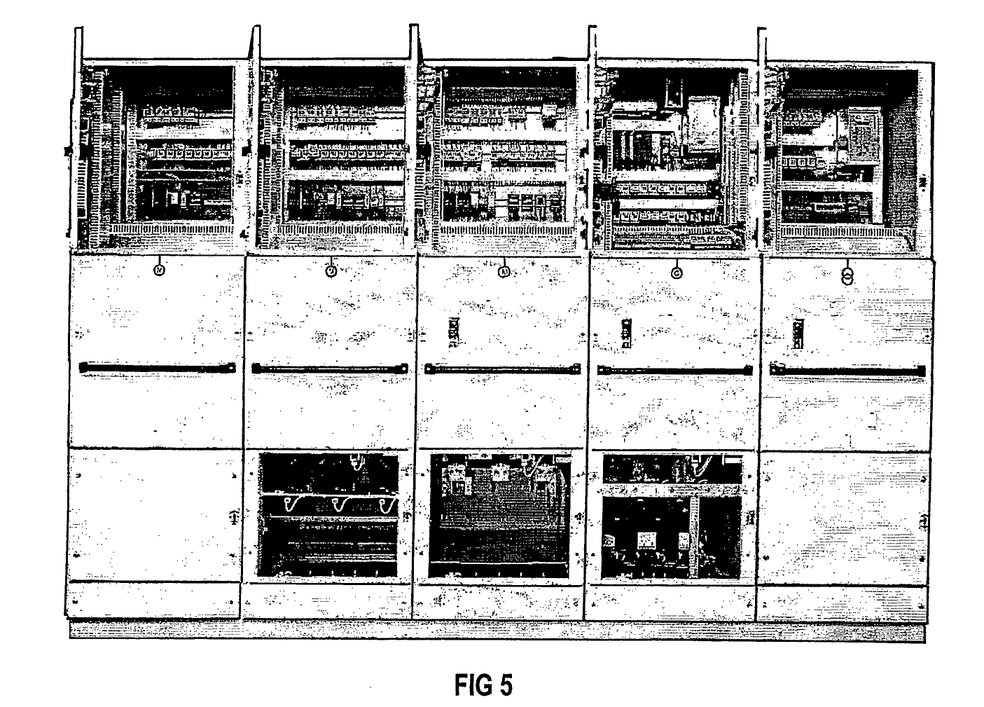

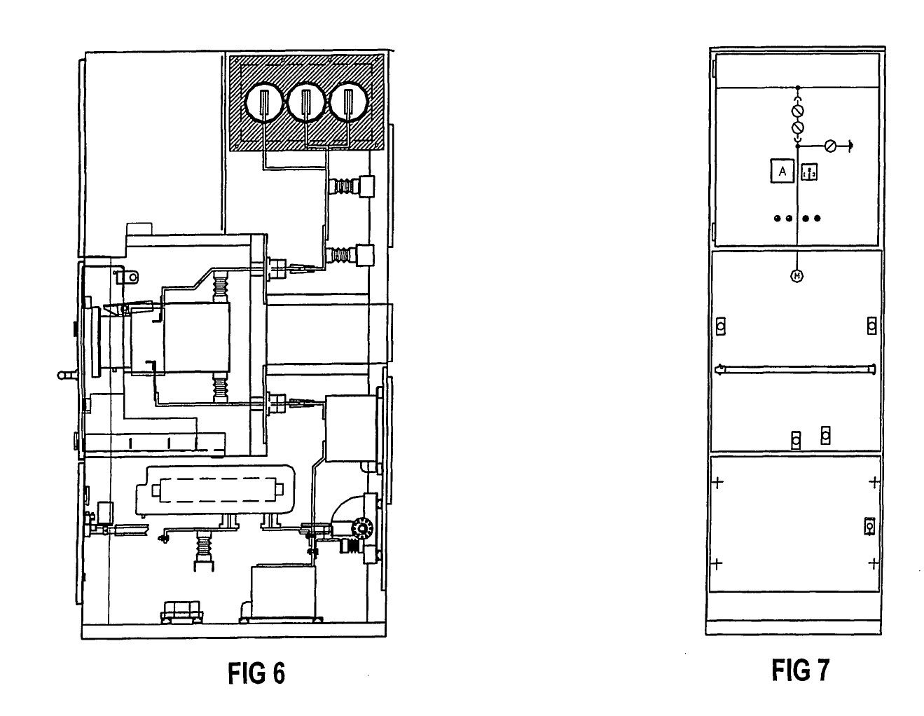

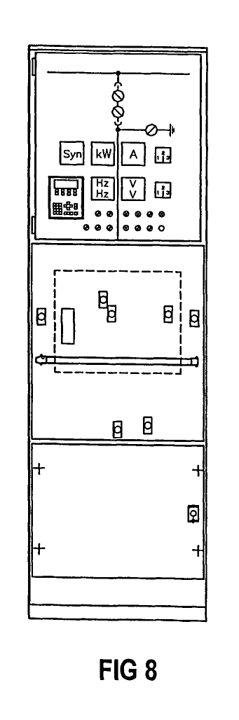

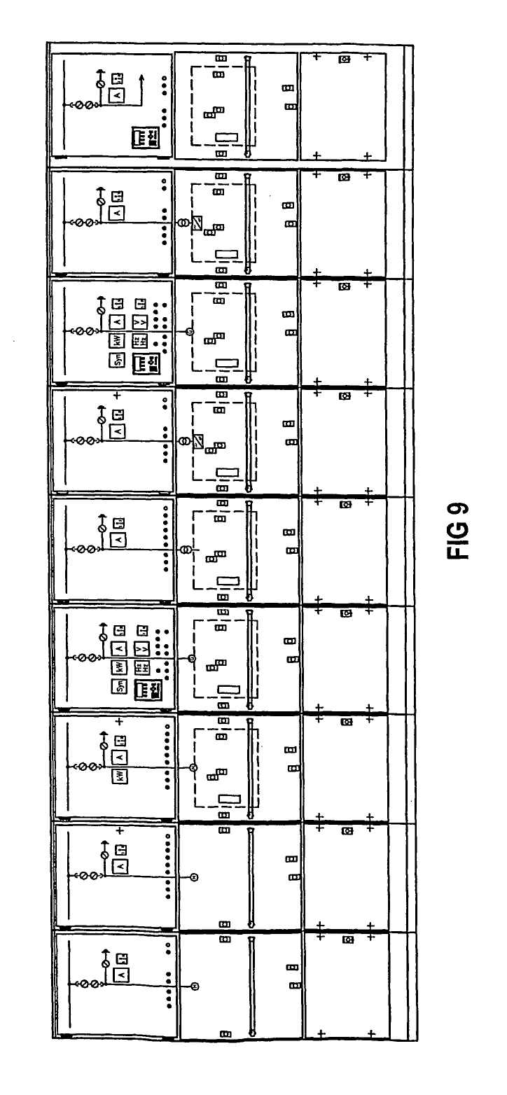

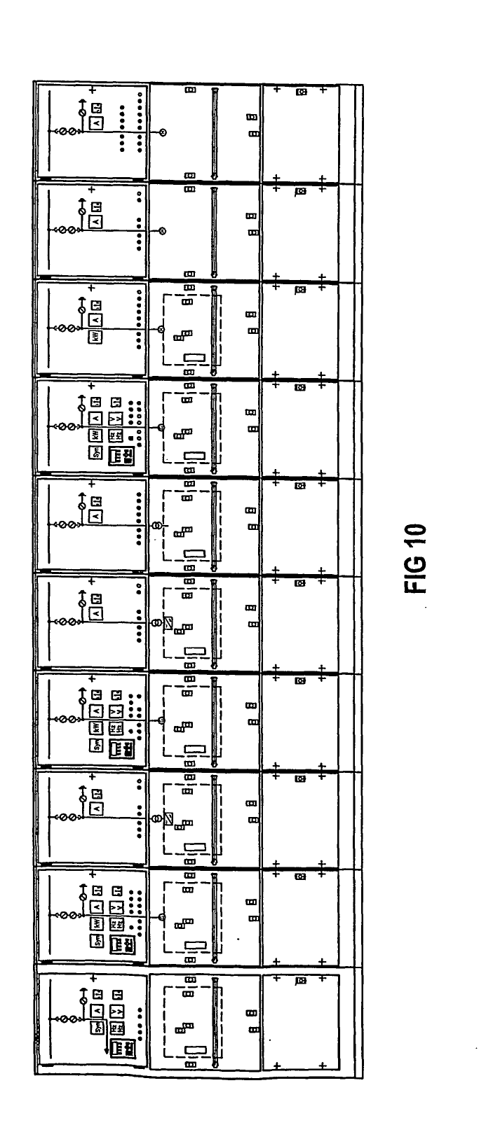

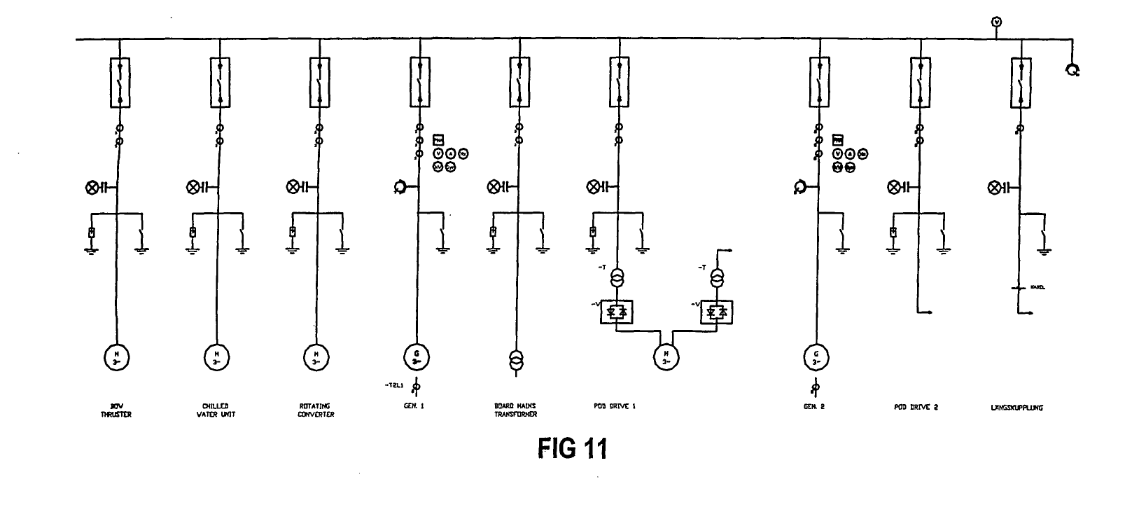

The circuit breaker 2 (see, e.g., FIG. 4) and/or the device combinations for load outgoers run on rails 3 and can be withdrawn from the assembly on the front side, with an electromechanical lock ensuring that the outgoer is disconnected before withdrawal. A test position is provided, and a spindle drive is used to make withdrawal and insertion easier.

The low-voltage parts 4 in the generator and load panels are partitioned on all sides such that they are separated from the medium-voltage part 5.

Generator Panel

The insert is provided with 3 3AH (vacuum interrupter) circuit breakers, 3 voltage converters, 3 current transformers, grounding switch.

Generator protection, PMA71, mechanical control elements are provided on the front panel 6 (see, e.g., FIG. 4) of the insert.

Similar arrangement for larger motor outgoers, for transformer outgoers, coupling panels, etc.

Load Panel 4

The insert is provided with 3AH (vacuum interrupter) circuit breaker, 3 current transformers, grounding switch in the load panels. The inserts themselves are partitioned from one another (resistant to fault arcs). Mechanical control elements are provided in the front panel of the insert.

Coupling Panel 5

The insert is provided with 3AH (vacuum interrupter) circuit breaker, 3 current transformers, grounding switch, synchronization. The inserts are also partitioned from one another (resistant to fault arcs) in the coupling panels. Mechanical control elements are provided in the front panel of the insert.

Ground fault protection

Ground fault protection monitoring, with direction identification and central signaling is provided for isolated networks or networks that are grounded with a high impedance.

Networks that are grounded with a high impedance can be extended to provide selective ground fault protection with automatic disconnection. To do this, a cable-type current transformer is provided in each selectively monitored outgoer, and a grounding resistance panel can be used for each generator.

Overcurrent and Short-Circuit Protection

The devices that are required for control and monitoring of the medium-voltage panels are accommodated in the respective low-voltage area of the panel. The instruments and control elements are arranged in the front.

Generator Panel 7

Differential protection

Short-term-delayed short-circuit protection

Overcurrent protection, return power protection

Synchronization device

Delayed undervoltage relay

Ground fault monitoring

Load Panel 4 with Circuit Breaker

Short-delay short-circuit protection

Overcurrent protection

Ground fault monitoring

Coupling Switch Panel 5

Short-term-delayed short-circuit protection

Overcurrent protection, synchronization devices

Ground fault monitoring

Voltage and frequency monitoring

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. A medium-voltage switchgear assembly, comprising:
a plurality of individual switchgear cabinets, wherein the individual switchgear cabinets comprise:
low-voltage panels with open-loop and closed-loop control devices, and
medium-voltage panels with circuit breakers.

2. The medium-voltage switchgear assembly as claimed in claim 1, configured for at least one of a marine vessel, a railroad, and a rail power supply.

3. The medium-voltage switchgear assembly as claimed in claim 1, further comprising: generator panels, load panels and coupling switch panels.

4. The medium-voltage switchgear assembly as claimed in claim 1, further comprising protective functional devices for the switchgear assembly that are integrated into the low-voltage panels.

5. The medium-voltage switchgear assembly as claimed in claim 1, wherein the low-voltage panels comprise programmable controllers.

6. The medium-voltage switchgear assembly as claimed in claim 5, wherein the programmable controllers are SIMATIC S-7 programmable controllers.

7. The medium-voltage switchgear assembly as claimed in claim 3, further comprising differential protective devices, short-term-delayed short-circuit devices, overcurrent protective devices, return power protective devices, synchronization devices, delayed undervoltage relays and ground fault monitoring devices for the generator panels.

8. The medium-voltage switchgear assembly as claimed in claim 3, further comprising short-delay short-circuit protective devices, overcurrent protective devices and ground fault monitoring devices for the load panels.

9. The medium-voltage switchgear assembly as claimed in claim 3, characterized in that the switchgear assembly has short-term-delayed short-circuit protective devices, overcurrent protective devices, synchronization devices, ground fault monitoring devices and voltage and frequency monitoring devices for the coupling switch panels.

10. The medium-voltage switchgear assembly as claimed in claim 1, wherein the individual switchgear cabinets comprise individual cabinet plates having welded tongue and fitting-hole connections in lieu of, at least in part, a rack construction.

11. The medium-voltage switchgear assembly as claimed in claim 1, further comprising:
circuit breakers,
rails for withdrawing the circuit breakers, and electromagnetic disconnection locks for the rails.

12. The medium-voltage switchgear assembly as claimed in claim 3, further comprising partitions arranged connected to the coupling switch panels.

13. The medium-voltage switchgear assembly as claimed in claim 1, further comprising pressure-relief flaps and blow-out areas.
